(19) United States
(12) Patent Application Publication
(10) Pub. No.: US 2012/0195491 A1
(43) Pub. Date: Aug. 2, 2012

(54) System And Method For Real-Time Mapping Of An Indoor Environment Using Mobile Robots With Limited Sensing

(75) Inventors: Ying Zhang, Cupertino, CA (US); Juan Liu, Milpitas, CA (US); Gabriel Hoffmann, Palo Alto, CA (US)

(73) Assignee: PALO ALTO RESEARCH CENTER INCORPORATED, Palo Alto, CA (US)

(21) Appl. No.: 12/841,065

(22) Filed: Jul. 21, 2010

(51) Int. Cl. G06K 9/00

(52) U.S. Cl. 382/153

(57) ABSTRACT

A system and method for real-time mapping of an indoor environment using mobile robots with limited sensing are provided. Raw trajectory data comprising a plurality of trajectory points is received from wall-following. Trace segmentation is applied to the raw trajectory data to generate line segments. The line segments are rectified to one another. A map is generated from the rectified line segments.

The U.S. Government has a paid-up license in this invention and the right in limited circumstances to require the patent owner to license others on reasonable terms as provided by the terms of Contract No. FA8650-08-C-7814 awarded by DARPA.

### FIELD

This application relates in general to characterization of a physical environment by mobile robots and, in particular, to a system and method for real-time mapping of an indoor environment using mobile robots with limited sensing.

### BACKGROUND

Mapping of, and localization within, an environment is critical for efficient and effective robot exploration and navigation. Mapping is useful for identifying features of the environment that can increase or hinder the objectives of the mobile robot. For example, identification of corners or intersections of hallways within an indoor environment is useful for surveillance and networking applications. Additionally, knowledge of whether a robot has previously traversed an area aids in conservation of battery life and time efficiency.

Mobile robots are often deployed in physical environments that are uncharted, remote, or inaccessible to conventional measuring techniques. To function most effectively, mobile robots need to discover the properties of the physical environment they are located in. Knowing details of the location can assist navigation, communication, and object retrieval or placement.

Mapping the physical environment can help determine the size of the area explored by the robot, and, if the robot gets stuck or otherwise blocked by an obstacle, allows the robot to return to a known, higher value area. The identification of the physical environment also helps to determine whether the entire area has been traversed, what part of the area has provided better connectivity between the robot, and any additional robots, and users, as well as optimization of movement of the robot, which maximizes battery life and minimizes time of exploration.

Generally, mobile robots use self-contained on-board guidance systems, which can include environmental sensors to track relative movement, detect collisions, identify obstructions, or provide an awareness of the immediate surroundings. Sensor readings are used to plan the next robotic movement or function to be performed. Movement can occur in a single direction or could be a sequence of individual movements, turns, and stationary positions.

Conventional modes of mapping of a physical environment by robots include using a comprehensive sensor suite with long-range sensors, such as cameras, ultrasonic rangers, and light detection and ranging (LIDAR) to detect obstacles in front of, or surrounding, the robot. Long-range measurement of the environment has a large overhead, both economically due to the high cost of components, and efficiency, due to high power demands. Additionally, high-level computer cognitive models are used for environment mapping but incur a high computational overhead that often requires external, and time delayed, computation. These requirements for sensor-rich robots and powerful computation can be beyond the capabilities low-power robots with short-range sensors.

Therefore, there is a need for an approach to on-board real-time mapping of an environment that is both cost-effective and efficient. Preferably, such an approach will be able to filter out errors created by sensor misreadings and obstacles within the physical environment.

### SUMMARY

Characteristics of a physical environment are determined based on data collected by a mobile robot. The mobile robot motion pattern and ongoing analysis of data received from sensors can be used for on-board real-time mapping of the environment by the mobile robot.

An embodiment provides a system and method for real-time mapping of an indoor environment using mobile robots with limited sensing. Raw trajectory data comprising a plurality of trajectory points is received from wall-following. Trace segmentation is applied to the raw trajectory data to generate line segments. The line segments are rectified to one another. A map is generated from the rectified line segments.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing, by way of example, a representative physical environment for deployment of a mobile robot.

FIG. 2 is a flow diagram showing, by way of example, a method for real-time mapping of an indoor environment using mobile robots with limited sensing.

FIG. 3 is a flow diagram showing wall-following for use in the method of FIG. 2.

FIG. 4 is a flow diagram showing trace segmentation for use in the method of FIG. 2.

FIG. 5 is a flow diagram showing map rectification for use in the method of FIG. 2.

FIG. 6 is a flow diagram showing loop detection and closure for use in the method of FIG. 2.

### DETAILED DESCRIPTION

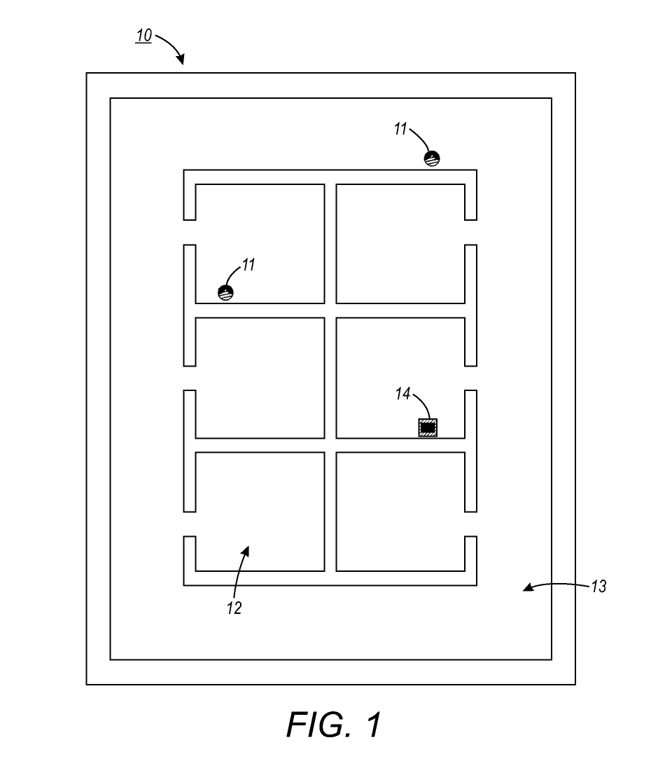

A physical environment is mapped in real-time based on motion patterns of a mobile robot. FIG. 1 is a block diagram showing, by way of example, a representative physical environment 10 for deployment of a mobile robot 11. The physical environment 10 can include one or more rooms 12 and hallways 13 separated by walls. Other components of the physical environment 10 are possible. One or more mobile robots 11 can be deployed within the physical environment 10. Additionally, one or more obstructions 14, or obstacles, can be in the environment 10.

The mobile robot 11 can include a power source, a communication interface to interface to other robots, base stations, and user nodes. The robot can also include motive power and a self-contained guidance system to move and guide the mobile robot about the environment, odometry to measure the distance traveled by, and position of, the mobile robot 11 within the environment, a left bump sensor and, optionally, a right bump sensor, and a heading component to calculate the heading of the robot around a 360 degree axis extending longitudinally through the center of the robot. In a further embodiment, the mobile robot 11 can include one or more short-range, such as infrared or ultrasonic, wall sensors for detection of an object, such as a wall, prior to the robot coming into physical contact with the object. Other robot 11 structures and components are possible.

The robot 11 can also include an interface to a processor that can be implemented as an embedded micro-programmed system or as a general-purpose portable computer system, such as a notebook computer. The processor includes one or more modules for analyzing data gathered by the robot to characterize the physical environment in which the robot is deployed, as described herein. The processor is a programmable computing device that executes software programs and includes, for example, a central processing unit, memory, network interface, persistent storage, and various components for interconnecting these components. The modules can be implemented as a computer program or procedure written as source code in a conventional programming language and is presented for execution by the central processing unit as object or byte code.

Alternatively, the modules could also be implemented in hardware, either as integrated circuitry or burned into read-only memory components. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components.

In one embodiment, the data gathered is analyzed in real-time by the embedded, or on-board, processor and the output stored for later access in memory. In another embodiment, the output is stored on an external computer interfaced to by the robot 11 through the network interface. In a still further embodiment, data collected from multiple robots 11 is, grouped, analyzed, and compared in combination with one another. Other data analysis and storage combinations are possible.

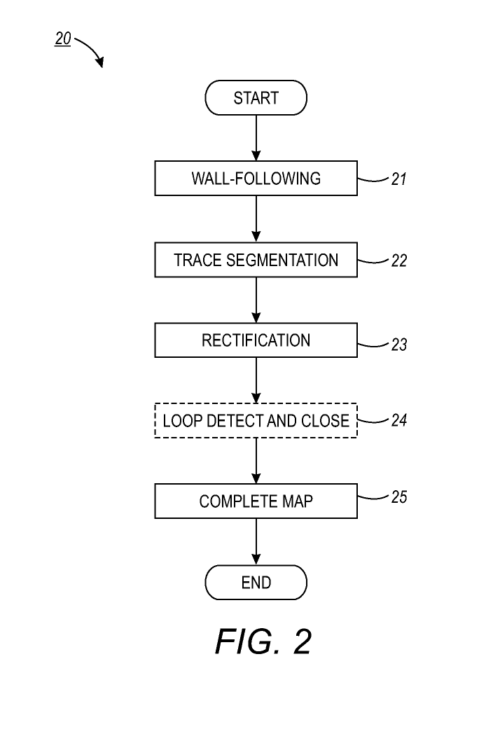

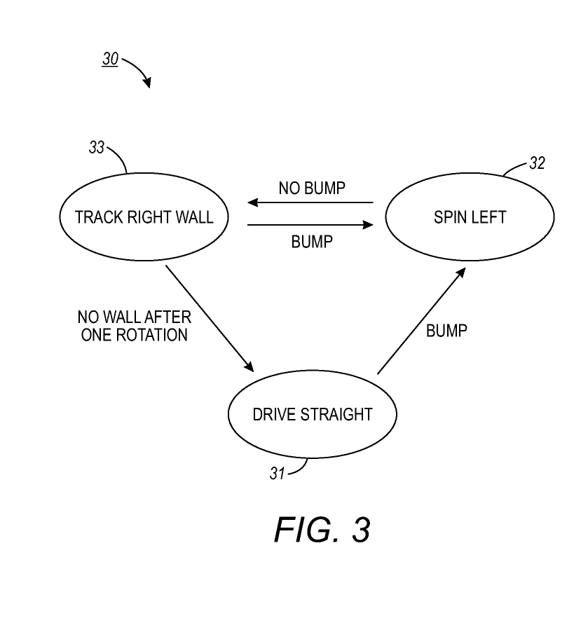

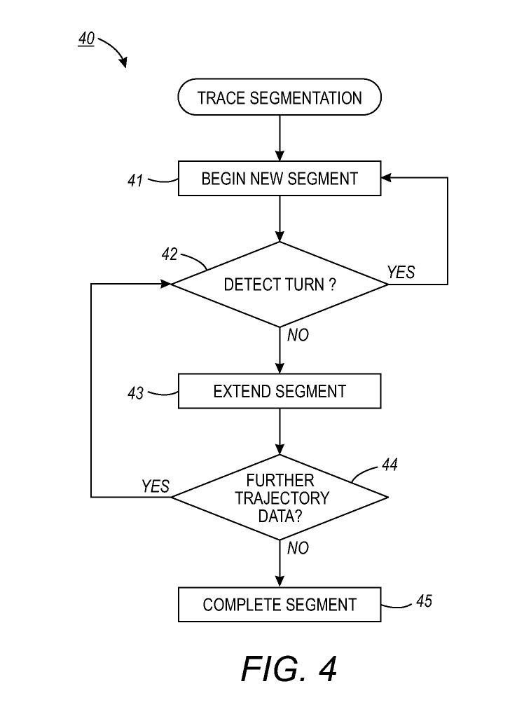

Raw data collected by the module robot 11 is analyzed to determine an environmental map in real-time. FIG. 2 is a flow diagram showing, by way of example, a method for real-time mapping of an indoor environment using mobile robots with limited sensing. The robot 11 moves around the environment 10 using a wall-following strategy (block 21), as further discussed below with reference to FIG. 3. Raw trajectory data, including distance traveled and turning angle is collected during the wall-following through the odometry. Further trajectory data can be collected from the wall sensor and bump sensors. The raw trajectory data is piecewise line fit using trace segmentation (block 22), as further discussed below with reference to FIG. 4.

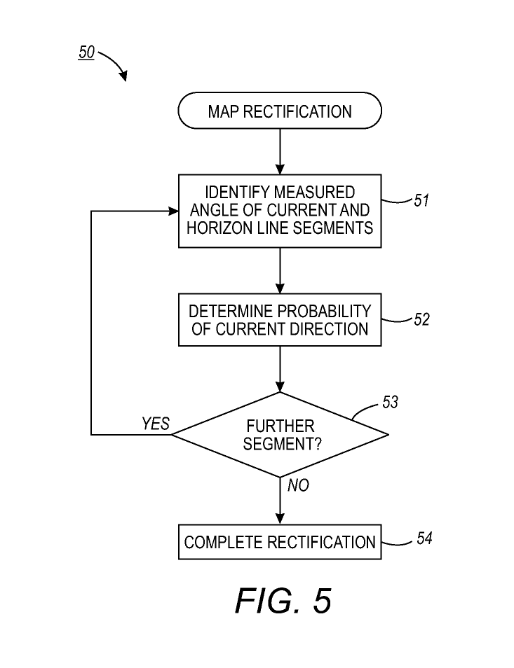

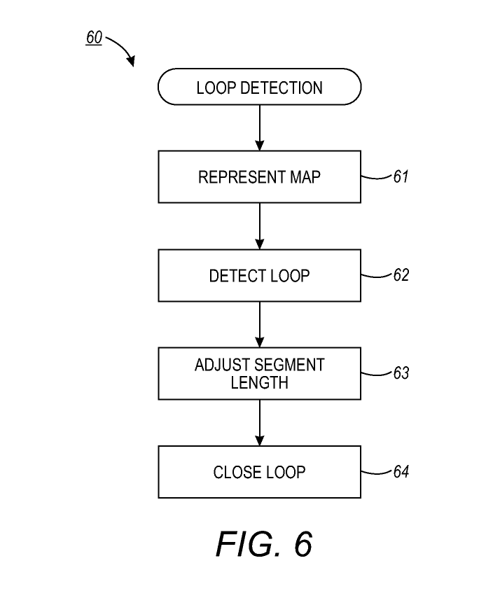

The line segments are then rectified so that they are either parallel or perpendicular to one another (block 23), as further discussed below with reference to FIG. 5. Optionally, any looping by the mobile robot 11 over previously traversed areas is detected and the loop can then be closed (block 24), as further discussed below with reference to FIG. 6. Finally, the map is completed (block 25).

Wall-following allows complete traversal of the boundary of an environment during robot 11 exploration. Additionally, regions previously traversed can be reached through reverse wall-following by travelling along the walls in the opposite direction than before without the need for accurate odometry. FIG. 3 is a flow diagram showing wall-following for use in the method of FIG. 2. Raw trajectory data, including distance traveled and orientation angle from odometry, wall sensor, and bumper sensor readings, are collected and stored during robot movement. Once introduced into an environment, data is collected by the robot 11 to determine if the wall sensor has detected a wall.

In one embodiment, a wall sensor located on the right side of the robot 11 is used for wall-following. If no wall is detected, the robot 11 rotates clockwise until the wall sensor is triggered. If the wall sensor is not triggered after a full rotation the robot 11 moves in a linear direction 31 until one or both of the bump sensors detects an object through contact, assumed to be a wall, and is triggered. Once one of the bump sensors is triggered, the robot 11 rotates counterclockwise 32 until the bump sensor is no longer triggered and then follows, or tracks, the wall 33 using the wall sensor.

The odometry collects distance and orientation angle data on a regular basis. The robot frame of reference is determined based on an initial positioning, or pose, of the robot when deployed in the physical environment. Alternatively, the pose of the robot can be reset to the initial position at anytime prior to collecting odometry readings. For example, the initial, or starting, position of the robot can be set to (x₀, y₀, ?₀), where x and y are coordinates and ? is orientation and, initially, are set to 0. Any current position (xₖ, yₖ, ?ₖ), when odometry data is collected, can be calculated by xₖ=xₖ₋₁+d cos(?ₖ), yₖ=yₖ₋₁ d sin(?ₖ), and ?ₖ=?ₖ+a, where d and a are current distance and angle measurements from the last point where a measurement was made, respectively. Other positioning determinations are possible.

Errors, or noise, in the odometry readings can occur due to quantization, such as errors in calculating orientation degree, and wheel slippage. Other sources of errors are possible. Distance errors are usually small while angle errors can be large due to roundoff and accumulator reset-when-read. For example, in one embodiment, the resolution of the sensors for distance is 0.001 meters and 1°, or 0.0175 radians, for angle measurements. The measurements of distance and angle are reset to 0 after each reading. If sampling time for a reading is too small or in cases where the angles change slowly such that the angle movement is less than 1° between samples, the reading of angles would be 0 even though the real movements accumulated can be positive or negative. Increasing the sampling rate may cause other source of errors such as delay of response. Other resolutions are possible, though may be limited by digitization. Errors are corrected based on assumptions made about the external environment, as further discussed below beginning with reference to FIG. 4.

Additionally, data is recorded from the left bumper (bl) and wall sensor (wr). When the left bump sensor is triggered, the bl reading is set to one, otherwise the reading is set to zero. A change in bump sensor reading from zero to one indicates the robot 11 is likely turning left, or counterclockwise. The wall sensor reading, wr, is set to one when the sensor measurement is above an intensity threshold, indicating an obstacle, assumed to be a wall, close to the right side of the robot 11. If the measurement is below the threshold, the robot is likely not close to an obstacle on the right side and the wall sensor reading is set to zero. In a further embodiment, the wall sensor is located on the left side of the robot 11. The wall-following strategy is then reversed, for example, the rotation of the robot when no wall is detected by the wall sensor is counterclockwise. Other wall-following strategies are possible.

The bumper and wall sensor readings can be collected on a regular, periodic, or intermittent basis. In one embodiment, the sensors are polled at 20 Hz, and raw trajectories (x, y, bl, wr) are stored both at 1 Hz and whenever a state of the bump sensor or wall sensor changes. Other data collection frequencies are possible.

Trace segmentation of collected data filters out common sensor errors and reduces computational overhead for mapping. FIG. 4 is a flow diagram showing trace segmentation for use in the method of FIG. 2. During trace segmentation, raw trajectory data collected from the odometry, bump sensor, and wall sensor is piecewise line fit. The individual trajectory points are clustered into short linear segments. The line segments are then rectified into discrete rectilinear directions using a probabilistic approach, as further discussed below with reference to FIG. 5. Clustering individual data points into line segments greatly reduces computation complexity, and subsequently, computation overhead for the robot, because rectification is applied to a smaller number of line segments instead of a larger number of individual points. Additionally, trace segmentation can remove some of the measurement and control noise. Although wall-following can generate zigzag or curved trajectories due to fine control strategies and sensor noises, segmentation produces consecutive lines that outline the boundaries of obstacles. In most indoor environments, walls or obstacles are straight and therefore can be captured by such filters efficiently.

Line segments are generated using input trajectories over time. For example, input data {xₖ, yₖ, blₖ, wrₖ}ₖ=_{1, 2, . . . , κ}, where (xₖ, yₖ) is the location coordinate, and blₖ and wrₖ are the left bumper and wall sensor readings, respectively, is used to generate output as line segment, represented by {lᵢ, ?ᵢ, tᵢ}, where l is length of a line segment, ? is orientation of the segment with respect to the robot's reference frame, in other words, the orientation with respect to the initial orientation, and t indicates whether the line segment has turned left, right, or is straight in reference to the previous line segment.

Initially, a line segment is begun (block 41) using the first two trajectory data points collected. Length, l, is determined according to the equation l=\sqrt{(x₂−x₁)²+(y₂−y₁)²}, where (x₁,y₁) and (x₂, y₂) are the location coordinate positions of the first and second trajectory points, respectively. Orientation of the segment is determined according to the equation ?=arctan(y₂−y₁, x₂−x₁), and t is initially set to straight. Each subsequent trajectory point is added to the current line segment until a turn is detected (block 42). When a turn is identified, a new line segment is begun with the next two trajectory data points.

Turns can be detected in a number of ways. The odometry, bump sensor, and wall sensor can provide information for determining a change in directions for the robot 11. A change in bump sensor state, blₖ, occurs when the bump sensor is triggered through contact with an obstacle. The state is set to 0 when the bump sensor is not triggered. When the left bump sensor has a current reading of blₖ=1, indicating bump sensor contact, and the previous data point, blₖ₋₁, was 0, then the robot has turned to the left and a new segment is begun, starting with blₖ, and t for the new segment is set to left.

When the wall sensor intensity is above a threshold value, the robot 11 is following the wall. The state of the wall sensor is set to 1 when above the threshold and is 0 when the intensity is below the threshold. When wrₖ=0 and wrₖ₋₁=1, the robot turns right in response to lost contact with the wall and t for the new segment is set to right.

Data collected through the odometry can be used to detect a change in direction as well. The distance from the current point to the current line segment is compared to the distance between the current point and previous points. The distance, dₖ, from the current point, (xₖ, yₖ), to the current line segment is determined according to the equation dₖ=|cos(?)(yₖ−y^{b})−sin(xₖ−x^{b})|, where (x^{b}, y^{b}) is the beginning point of the current segment and ? is the orientation of the current segment, where ?=arctan(yₖ−y^{b}, xₖ−x^{b}). The distance from the current point, (xₖ, yₖ), to the previous point, (xₖ₋₁, yₖ₋₁), is determined according to the equation d̅=\sqrt{(xₖ−xₖ₋₁)²+(yₖ−yₖ₋₁)²}.

When dₖ=κ d̅, where κ is a constant between 0 and 1 that is a threshold for the minimum turning angle between segments, a new segment is created. Otherwise, the current segment is extended (block 43) to include the current point. In one embodiment, K is set to 0.1. In a further embodiment, l, the length of the current segment, is compared to parameter L, which is a set minimum segment length. If l>L and dₖ=κ d̅, then a new segment is created. Otherwise, the current segment is extended to include the current point. In one embodiment, L is set to 0.7 meters but other minimum segment lengths are possible. When no further trajectory data is collected or once a turn is detected, the current segment is completed (block 45). Trace segmentation is applied to each additional trajectory data collected in real-time.

Trace segmentation produces line segments that fit to the trajectory of the wall-following of the robot 11 but due to odometry errors, the trajectories can be deformed due to measurement noise. Rectification corrects the deformations by making the line segments either parallel or perpendicular to one another. FIG. 5 is a flow diagram showing map rectification for use in the method of FIG. 2. Many indoor environments are rectilinear with perpendicular walls and the rectilinear interior can be used to correct noise in the line segments. The input of the rectification is a sequence of line segments (lᵢ, ?ᵢ, tᵢ) generated from trace segmentation, and the output is a new sequence of line segments (lᵢ, sᵢ), where s is the rectified angle. A constraint is applied so that any two neighboring segments are either aligned or rectilinear. Once rectified, each segment is a multiple of p/2 from one another.

In one embodiment, the turning angle between two neighboring segments is examined and classified into discrete angles, for example, 0°, 90°, and so on using a straight-forward classification algorithm. A turning angle smaller than a threshold, for example, 45°, is classified as 0°, or straight, otherwise the turning angle is classified as a rectilinear turn. But this classification algorithm can be problematic in some instances. For example, in the case of four line segments, with direction ?ᵢ=0°, 30°, 60°, and 90°, respectively, the turning angle between any two concurrent segments is only 30°, hence the straight-forward classification algorithm will classify each turning angle as 0°. However, the robot has actually finished a 90° turn. This problem can be fixed by extending the classification from the stateless classification of instantaneous turning angles described above to a state-based classification with turning angle history.

In a further embodiment, each line segment is rectified using not only the turning angle of the particular line segment but also a history horizon of previous line segments turning angles (block 51). For a line segment, i, the turning angle of the segment along with the history {i−1, i−2, . . . , i−H} is considered, where H is the horizon length. The horizon length is the number of previous line segments that are taken into consideration to determine the turning angle of the current line segment and can be defined in a number of ways. For example, the horizon length can be the line segments within a physical distance, such as five meters, of the current segment. Alternatively, the horizon length can be defined as a set number of line segments prior to the current line segment. Other types of horizon lengths are possible. In any case, the line segments within the horizon are collectively considered to rectify the current line segment and can avoid the problems with the stateless classification described above. Furthermore, use of the history horizon can remove noisy data and provide move accurate mapping in the presence of obstacles when the obstacles are small in size compared to the history horizon since the line segments before and after the obstacle are used for rectification.

Next, the probability of the orientation of the current segment is described (block 52). In one embodiment, approximate sequential Bayesian filtering is used to recursively update an estimate of the posterior of underlying state sᵢ₊₁ with observation sequences z̅ᵢ̅₊̅₁̅={z₀, z₁, . . . , zᵢ₊₁} and given by the equation:

p(sᵢ₊₁| z̅ᵢ̅₊̅₁̅)∝·pₐ(zᵢ₊₁|sᵢ₊₁)·∫ₛp_{d}(sᵢ₊₁|sᵢ)·p(sᵢ| z̅ᵢ̅)dsᵢ. (1)

Equation (1) is sequential, the belief p(sᵢ₊₁| z̅ᵢ̅₊̅₁̅) is computed from the belief p(sᵢ| z̅ᵢ̅) from the previous time i at each step. The integral in Equation (1) is a single step of prediction bringing the previous state sᵢ up to the current time sᵢ₊₁ and then a new external measurement zᵢ₊₁ is applied to modify the state. The prediction is then multiplied by a likelihood, reflecting the contribution of observation zᵢ₊₁ using an observation model, pₒ(zᵢ₊₁|sᵢ₊₁).

Two key components that are essential in the sequential Bayesian filtering approach are the dynamics model, p_{d}(sᵢ₊₁|sᵢ), and the observation model, pₒ(z|s).

The dynamics model describes the evolution, or drifting, of the underlying state. Here, sᵢ is the orientation directions {sᵢ, sᵢ₊₁, . . . , s_{i-H}}. Since the line segments defining the walls are assumed rectilinear, or to intersect each other at perpendicular angles, the model is given by the equation:

$${s}_{i + 1} = \{ \begin{matrix}{s}_{i} & {p}_{S} = 0.5 ; & \% straight \\ {s}_{i} + π & {p}_{U} = 0.1 ; & \% U \text{-} Turn \\ {s}_{i} - \frac{π}{2} & {p}_{L} = 0.2 ; & \% right turn \\ {s}_{i} + \frac{π}{2} & {p}_{R} = 0.2 ; & \% left turn\end{matrix} \qquad ( 2 )$$

Although the above particular probability distribution is used, other distributions are possible. For example, the above model can be extended to eight directions instead of four for environments that have many 45 degree angles.

Next, the observation model describes the relationship between the underlying states and measurement observations. The measurements of turning angle ? from the odometry are used over the history horizon, where z={?ᵢ, ?ᵢ₋₁, . . . ?_{i-H}}. An assumption is made that the measured turning angle is the true turning angle but is contaminated with noise, for example, ?ᵢ₊₁−?ᵢ₋ⱼ=sᵢ,−sᵢ₋ⱼ,+nⱼ where j indicates the j-th previous segment and nⱼ is noise.

In one embodiment, a generalized Gaussian distribution (GGD) is used as a model for the noise. Though, other noise models are possible. The GGD is parameterized by a shape parameter, r, and a standard deviation, s. In a further embodiment, GGD includes Gaussian distributions as a special case, when r=2, but is more flexible because the shape parameter r can be varied to describe noise with heavy tails (when r<2). This can be necessary for modeling angle noise because odometry data can be quite noisy, especially when the line segment length is short. For example, when a robot 11 is almost stationary, any angle measurement from odometry is possible, in other words, ?=arctan(y₂−y₁,x₂−x₁) is arbitrary when the distance between (x₁,y₁) and (x₂,y₂) is very small or approaching zero. In one embodiment, a shape parameter, where r=0.5 and a standard deviation of 10° for n₁ and (H−1)·20° for nⱼ where 1<j=H are used. Other shape parameter and standard deviation amounts are possible.

In a further embodiment, the turn information, where t=(STRAIGHT, LEFT, RIGHT), obtained from trace segmentation, as described above with reference to FIG. 3, is used in rectification. A simple likelihood function, p(t|s)=1, is applied if the turn state in the hypothesis determined above agrees with the turn observation 1, and p(t|s)=0.5 if the two do not agree. Hypotheses are discounted, such as by half, that conflict with sensor observations. The observation likelihood is multiplied to that of the odometry data, assuming that the different sensing modalities are independent of one another, since an assumption is made that odometry error is independent to bumper and wall sensor error.

The rectification process then takes the line segment inputs over time and maintains up to N, for example, 100, of the most probable state sequences and their respective probabilities pₙ. Whenever a new line segment (l, ?, t) is determined (block 53), each existing state sequence (s₀, s₁, . . . sᵢ) forks into four possibilities, with the new traveling direction sᵢ₊₁ being straight, a left turn, a right turn, or a U-turn. Probabilities of the new state sequences are updated using the dynamics model and observation model as described above. State sequences with low probabilities (pₙ<1/N) are discarded, and up to N most probable state sequences are kept, the probabilities are then renormalized to sum up to 1 by pₙ? pₙ/P and P is ? pₙ, which leads up to the next update when a new segment is determined. The final mapping result is the most probable state sequence (block 54).

Detecting whether the robot 11 is looping around the environment by traversal over the same area is important to conserve time and efficient power usage. If looping is detected, the robot 11 may cease further movement or migrate to previously unexplored areas. FIG. 6 is a flow diagram showing loop detection and closure for use in the method of FIG. 2. Since the environment map is generated from line segments, the map can be represented (block 61) by a one-dimensional function. In one embodiment, the function is represented as s(d), where d is the traveled distance from the robot 11 starting position, or point, and s(d) is the wall orientation at that point.

In a further embodiment, s can be accumulated turn counts (ATC) at a particular distance from the staring position. For example, a left turn can be assigned a value of 1, while a right turn is assigned a value of −1. ATC is the sum of all turns up to the current point. High positive or low negative, such as =10 or =−10, ATC counts can indicate a loop. ATC counts of 4 or −4 indicate, a complete left or right circle. Other values for s are possible.

In any event, wall orientation ?, is then s·p/2. Loop detection is performed whenever a new segment (l, ?, t) is rectified. In particular, if the location of the first corner of the rectified map is (x₁, y₁), and there are already (x₀, y₀), (x₁, y₁), (x₂, y₂), . . . , (xₘ, yₘ) points in the map, a loop is detected (block 62) at (lₘ₊₁, sₘ₊₁) if the following three conditions are satisfied:
1) sₘ=2p or sₘ=−2p, in other words, a full turn around in angles by the robot 11;
2) sₘ₊₁? sₘ, in other words, a corner at turn around; and
3) \sqrt{(xₘ−x₁)²+(yₘ−y₁)²}<pΣᵢ₌₁^{m}lᵢ, where (xₘ, yₘ) is the location of the last corner in the rectified map and p is a small scale distance factor, for example 0.1, though other distance factors are possible, and lᵢ is distance between (i−1)'th and i'th points.

In some structures, loop detection can be difficult or even fail due to odometry error or error introduced by mapping, for example, linearization of curved wall segments or rectification of non-rectilinear segments. In a further embodiment, autocorrelation in the rectified segment sequence can be determined to find the corresponding matching points. When the robot 11 is looping while wall-following, the sequence s(d) may appear repetitive, for example, a portion of the sequence can be similar to another portion of the sequence. Such similarities can be detected via signal correlation. Even though the robot 11 may initially miss the closing point, the robot 11 can identify the closing point after detecting the autocorrelation in the rectified segment sequence. In particular, if there is a loop in s₁, s₂, . . . , sₘ, sₘ₊₁ . . . , the sequence starting from sₘ would be similar to that from s₁.

Once segment correspondence is determined in a loop, the lengths of the line segments are adjusted (block 63) by subtracting estimated error, ? from lᵢ for each segment i to close the loop (block 64) at the first overlapping corner at the end of segment m. Maximum likelihood estimation is used to find ?=[?₁ . . . ?ₘ]^{T}. The estimated orientation of the segments remains unchanged. Line segment length, lᵢ, is assumed to have zero mean Gaussian noise with variance σᵢ². That is, ?ᵢ˜N(0, σᵢ²).

If σᵢ²∝lᵢ is assumed, cumulative Gaussian noise on odometry, σᵢ²=lᵢ can be used because the proportionality constant factors out in the minimization further described below. On the other hand, if assume error or noise is independent of distances, which are caused mainly by turns, σᵢ²=1 can be used. The maximum likelihood estimate of ? is the solution to

$${minimize}_{Δ ∈ {n}^{}} {\sum }_{i = 1}^{m} {( \frac{{Δ}_{i}}{{σ}_{i}} )}^{2} \\ subject to \begin{matrix}{\sum }_{i = 1}^{m} ( {l}_{i} - {Δ}_{i} ) cos {θ}_{i} = 0 \\ {\sum }_{i = 1}^{m} ( {l}_{i} - {Δ}_{i} ) sin {θ}_{i} = 0\end{matrix} \qquad ( 3 )$$

By defining

$${Z}_{i} = \frac{{Δ}_{i}}{{σ}_{i}} ,$$

this can be reformulated as a least norm problem,

$${minimize}_{Δ ∈ {n}^{}} {\sum }_{i = 1}^{m} {z}_{i}^{2} \\ subject to [ \begin{matrix}{( σ ∘ cos θ )}^{T} \\ {( σ ∘ sin θ )}^{T}\end{matrix} ] z = {\sum }_{i = 1}^{m} ( {σ}_{i} [ \begin{matrix}cos {θ}_{i} \\ sin {θ}_{i}\end{matrix} ] ) \qquad ( 4 )$$

where ∘ is the Hadamard (element-wise) product, ?=[?₁ . . . ?ₘ]^{T}, and s=[s₁ . . . sₘ]^{T}. The solution is then given by

$$\begin{matrix}\begin{matrix}A = [ \begin{matrix}{( σ ∘ cos θ )}^{T} \\ {( σ ∘ sin θ )}^{T}\end{matrix} ] \\ = [ \begin{matrix}{σ}_{1} cos {θ}_{1} … {σ}_{m} cos {θ}_{m} \\ {σ}_{1} sin {θ}_{1} … {σ}_{m} sin {θ}_{m}\end{matrix} ] ( 6 )\end{matrix} & ( 5 ) \\ ? = σ ∘ ( {{A}^{T} ( {AA}^{T} )}^{- 1} {\sum }_{i = 1}^{m} ( {l}_{i} [ \begin{matrix}( cos {θ}_{i} ) \\ ( sin {θ}_{i} )\end{matrix} ] ) ) & ( 7 )\end{matrix}$$

Note that the matrix being inverted is 2×2, which is can be easily computed analytically for on-board real-time implementation.

Loop detection can be used to not only to identify and close looping from one mobile robot 11 but also to find similarity between partial or completed maps determined by two or more different robots and merge the maps into one. Additionally, multiple smaller maps can be combined into a larger map by aligning the matching portions of the maps. Further, a map generated by the mobile robot can be compared or aligned against another, perhaps, larger, prior known map, such as described in commonly-assigned U.S. patent application Ser. No. ______, entitled “System and Method for Aligning Maps Using Polyline Matching,” filed Jul. 21, 2010, pending, the disclosure of which is incorporated by reference.

While the invention has been particularly shown and described as referenced to the embodiments thereof, those skilled in the art will understand that the foregoing and other changes in form and detail may be made therein without departing from the spirit and scope of the invention.

What is claimed is:

1. A system for real-time mapping of an indoor environment using mobile robots with limited sensing, comprising:
raw trajectory data comprising a plurality of trajectory points from wall-following;
a segmentation module applying trace segmentation to the raw trajectory data to generate line segments;
a rectification module rectifying the line segments to one another; and
a map module generating a map from the rectified line segments.

2. A system according to claim 1, further comprising:
a line segment module generating an initial line segment with two of the trajectory points and extending the line segment through each of the next trajectory points until a turn is detected.

3. A system according to claim 2, wherein the turn is detected through a change in one of a bump sensor state, a wall sensor state, and odometry.

4. A system according to claim 1, wherein a current line segment is rectified using a history horizon of the current line segment.

5. A system according to claim 4, wherein the history horizon is a neighborhood of line segments within a distance of the current line segment.

6. A system according to claim 1, further comprising:
a constraint module applying a constraint so any two neighboring line segments are one of aligned or rectilinear to one another.

7. A system according to claim 1, wherein the line segments are rectified according to the equation:
p(sᵢ₊₁| z̅ᵢ̅₊̅₁̅)∝·pₒ(zᵢ₊₁|sᵢ₊₁)·∫ₛp_{d}(sᵢ₊₁|sᵢ)·p(sᵢ| z̅ᵢ̅)dsᵢ
where p is probability of a rectified sequence given the sequence of measurements, s is state, in this case, orientation of a segment, z is observation, including both odometry and sensor observations, p(sᵢ₊₁| z̅ᵢ̅₊̅₁̅) is computed from the belief p(sᵢ| z̅ᵢ̅) from the previous time, i, at each step, zᵢ₊₁ is observation, pₒ(zᵢ₊₁|sᵢ₊₁), pₒ(z|s) is an observation model, p_{d}(sᵢ₊₁|sᵢ) is a dynamics model, ? is turning angle, where z={?ᵢ, ?ᵢ₋₁, . . . ?_{i-H}}, and H is a history horizon.

8. A system according to claim 1, further comprising:
an orientation module identifying an orientation angle of a current line segment and a history horizon comprising one or more line segments prior to the current line segment; and
a probability module determining a plurality of probabilities of a current direction of the current line segment and each of the line segments of the history horizon and completing the map using the most probable direction for each of the line segments.

9. A system according to claim 1, further comprising:
a loop module identifying a loop within the rectified line segments and closing the loop to generate a closed map.

10. A system according to claim 1, further comprising:
a representation module representing the map as a one-dimensional function;
a loop module detecting a loop comprising overlapping line segment within the map;
an error module adjusting line segment length of the overlapping line segments by an estimated error; and
a closure module closing the loop at the intersection of the adjusted line segments.

11. A method for real-time mapping of an indoor environment using mobile robots with limited sensing, comprising:
receiving raw trajectory data comprising a plurality of trajectory points from wall-following;
applying trace segmentation to the raw trajectory data to generate line segments;
rectifying the line segments to one another; and
generating a map from the rectified line segments.

12. A method according to claim 11, further comprising:
generating an initial line segment with two of the trajectory points; and
extending the line segment through each of the next trajectory points until a turn is detected.

13. A method according to claim 12, wherein the turn is detected through a change in one of a bump sensor state, a wall sensor state, and odometry.

14. A method according to claim 11, further comprising rectifying a current line segment using a history horizon of the current line segment.

15. A method according to claim 14, wherein the history horizon is a neighborhood of line segments within a distance of the current line segment.

16. A method according to claim 11, further comprising applying a constraint so any two neighboring line segments are one of aligned or rectilinear to one another.

17. A method according to claim 11, wherein the line segments are rectified according to the equation:
p(sᵢ₊₁| z̅ᵢ̅₊̅₁̅)∝·pₒ(zᵢ₊₁|sᵢ₊₁)·∫ₛp_{d}(sᵢ₊₁|sᵢ)·p(sᵢ| z̅ᵢ̅)dsᵢ
where p is probability of a rectified sequence given the sequence of measurements, s is state, in this case, orientation of a segment, z is observation, including both odometry and sensor observations, p(sᵢ₊₁| z̅ᵢ̅₊̅₁̅) is computed from the belief p(sᵢ| z̅ᵢ̅) from the previous time, i, at each step, zᵢ₊₁ is observation, pₒ(zᵢ₊₁|sᵢ₊₁), pₒ(z|s) is an observation model, p_{d}(sᵢ₊₁|sᵢ) is a dynamics model, ? is turning angle, where z={?ᵢ, ?ᵢ₋₁, . . . ?_{i-H}}, and H is a history horizon.

18. A method according to claim 11, further comprising:
identifying an orientation angle of a current line segment and a history horizon comprising one or more line segments prior to the current line segment;
determining a plurality of probabilities of a current direction of the current line segment and each of the line segments of the history horizon;
completing the map using the most probable direction for each of the line segments.

19. A method according to claim 11, further comprising:
identifying a loop within the rectified line segments; and
closing the loop to generate a closed map.

20. A method according to claim 11, further comprising:
representing the map as a one-dimensional function;
detecting a loop comprising overlapping line segment within the map;
adjusting line segment length of the overlapping line segments by an estimated error; and
closing the loop at the intersection of the adjusted line segments.
